(19) United States
(12) Patent Application Publication
(10) Pub. No.: US 2025/0219873 A1
(43) Pub. Date: Jul. 3, 2025

(54) METHOD AND APPARATUS FOR RECEIVING PTRS IN WIRELESS COMMUNICATION SYSTEM

(71) Applicant: Samsung Electronics Co., Ltd., Suwon-si (KR)

(72) Inventors: Dongjae LEE, Suwon-si (KR); Ikbeom LEE, Suwon-si (KR)

(21) Appl. No.: 19/085,217

(22) Filed: Mar. 20, 2025

Related U.S. Application Data
(63) Continuation of application No. PCT/KR2023/014023, filed on Sep. 18, 2023.

(30) Foreign Application Priority Data
Sep. 21, 2022 (KR) 10-2022-0119112
Sep. 28, 2022 (KR) 10-2022-0123393

(51) Int. Cl. H04L 25/02

(52) U.S. Cl. CPC H04L 25/0224

(57) ABSTRACT

The present disclosure describes a method and apparatuses for a UE or a base station to receive a phase tracking reference signal (PTRS) in a wireless communication system. The method by which a UE receives a PTRS in a wireless communication system, according to various embodiments, may comprise: acquiring a first CFR estimate value in a resource element (RE) to which the PTRS has been allocated, by performing linear interpolation on the basis of two REs to which a demodulation reference signal (DMRS) has been allocated; calculating an estimate value a CPE angle difference for the RE to which the PTRS has been allocated; and on the basis of a second CFR estimate value acquired by applying the estimate value of the CPE angle difference to the first CFR estimate value, performing phase tracking of the RE to which the PTRS has been allocated.

### CROSS-REFERENCE TO RELATED APPLICATIONS

This application is a continuation of International Application No. PCT/KR2023/014023 designating the United States, filed on Sep. 18, 2023, in the Korean Intellectual Property Receiving Office and claiming priority to Korean Patent Application Nos. 10-2022-0119112, filed on Sep. 21, 2022, and 10-2022-0123393, filed on Sep. 28, 2022, in the Korean Intellectual Property Office, the disclosures of each of which are incorporated by reference herein in their entireties.

### BACKGROUND

### Field

The disclosure relates to a wireless communication system and, for example, to a method and apparatus for receiving a PTRS for phase noise estimation in a wireless communication system.

### Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to enable compensation for phase noise that may occur during signal transmission and reception, a phase tracking reference signal (hereinafter, PTRS) has been introduced in new radio (NR). In general, phase noise increases as a function of oscillator carrier frequency. In an orthogonal frequency division multiplexing (OFDM) signal, degradation due to phase noise is the same phase rotation of all subcarriers, which is known as a common phase error (CPE). A PTRS may be used at high carrier frequencies (e.g., frequency range 2 (FR2) where millimeter wave or mmWave is used) to mitigate phase noise.

Since a phase rotation generated by a CPE is the same for all subcarriers within an OFDM symbol, a PTRS has low density in the frequency domain and has high density in the time domain. A PTRS is specific to a UE device, limited to a scheduled resource block (RB), and may be beamformed. The number of PTRS ports may be fewer than the total number of demodulation reference signal (DMRS) ports, and orthogonality between the PTRS ports is achieved by FDM. A PTRS may be configured according to the quality of an oscillator, an allocated bandwidth (BW), a carrier frequency, an OFDM subcarrier spacing, and modulation and coding schemes used for transmission.

Recently, with the development of wireless communication systems, research on ways to utilize PTRS in next-generation communication systems is actively being conducted. Accordingly, there is an increasing demand for technology of channel estimation using radio resources allocated to PTRS.

### SUMMARY

Embodiments of the disclosure provide a method and apparatus for receiving a PTRS to estimate phase noise in a wireless communication system.

According to various example embodiments, a method for receiving a phase tracking reference signal (PTRS) by a terminal in a wireless communication system may include: performing linear interpolation based on two resource elements (REs) to which a demodulation reference signal (DMRS) has been assigned, thereby acquiring a first channel frequency response (CFR) estimation value in an RE to which a PTRS has been assigned, calculating an estimation value of a common phase error (CPE) angle difference for the RE to which the PTRS has been assigned, and based on a second CFR estimation value acquired by applying the estimation value of the CPE angle difference to the first CFR estimation value, performing phase tracking of the RE to which the PTRS has been assigned.

According to various example embodiments, a terminal for receiving a phase tracking reference signal (PTRS) in a wireless communication system may include: a transceiver and a controller coupled with the transceiver is configured to: perform linear interpolation based on two resource elements (REs) to which a demodulation reference signal (DMRS) has been assigned to acquire a first channel frequency response (CFR) estimation value in an RE to which a PTRS has been assigned, calculate an estimation value of a common phase error (CPE) angle difference for the RE to which the PTRS has been assigned, and based on a second CFR estimation value acquired by applying the estimation value of the CPE angle difference to the first CFR estimation value, perform phase tracking of the RE to which the PTRS has been assigned.

According to various example embodiments, a method for receiving a phase tracking reference signal (PTRS) by a base station in a wireless communication system may include: performing linear interpolation based on two resource elements (REs) to which a demodulation reference signal (DMRS) has been assigned, thereby acquiring a first channel frequency response (CFR) estimation value in an RE to which a PTRS has been assigned, calculating an estimation value of a common phase error (CPE) angle difference for the RE to which the PTRS has been assigned, and based on a second CFR estimation value acquired by applying the estimation value of the CPE angle difference to the first CFR estimation value, performing phase tracking of the RE to which the PTRS has been assigned.

According to various example embodiments, a base station for receiving a phase tracking reference signal (PTRS) in a wireless communication system may include: a transceiver and a controller coupled with the transceiver is configured to: perform linear interpolation based on two resource elements (REs) to which a demodulation reference signal (DMRS) has been assigned, to acquire a first channel frequency response (CFR) estimation value in an RE to which a PTRS has been assigned, calculate an estimation value of a common phase error (CPE) angle difference for the RE to which the PTRS has been assigned, and based on a second CFR estimation value acquired by applying the estimation value of the CPE angle difference to the first CFR estimation value, perform phase tracking of the RE to which the PTRS has been assigned.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating resource elements (REs) to which a phase tracking reference signal (PTRS) has been assigned in a wireless communication system according to various embodiments;

FIG. 2 is a graph illustrating a common phase error (CPE) according to various embodiments;

FIG. 3 is a graph illustrating a channel frequency response (CFR) according to various embodiments;

FIG. 4 is a diagram illustrating OFDM symbols in a specific subcarrier along the time axis according to various embodiments;

FIG. 5 is a flowchart illustrating an example channel estimation operation of a UE according to various embodiments;

FIG. 6 is a flowchart illustrating an example channel estimation operation of a UE according to various embodiments;

FIG. 7 is a flowchart illustrating an example channel estimation operation of a UE according to various embodiments;

FIG. 8 is a flowchart illustrating an example channel estimation operation of a UE according to various embodiments;

FIG. 9 is a graph illustrating example block error rate (BLER) versus signal-to-noise ratio (SNR) according to various embodiments; and

FIG. 10 is a graph illustrating example BLER versus SNR according to various embodiments;

FIG. 11 is a block diagram illustrating an example configuration of a UE according to various embodiments; and

FIG. 12 is a block diagram illustrating an example configuration of a base station according to various embodiments.

With regard to the description of the drawings, the same or like reference signs may be used to designate the same or like elements.

### DETAILED DESCRIPTION

Various example embodiments are described in greater detail with reference to the drawings, wherein like reference numerals are used to refer to like elements throughout. In the following description, for purposes of explanation, numerous specific details are set forth in order to provide a thorough understanding of one or more aspects. It may be apparent, however, that such aspect(s) may be practiced without these specific details.

The terms used in the disclosure are used merely to describe various embodiments, and may not be intended to limit the scope of the disclosure. A singular form of a noun corresponding to an item may include one or more of the items, unless the relevant context clearly indicates otherwise. The terms used herein, including technical and scientific terms, may have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

In the following description, terms referring to signals (e.g., message, signal, signaling, sequence, and streams), terms referring to resources (e.g., symbol, slot, subframe, radio frame (RF), subcarrier, resource element (RE), resource block (RB), bandwidth part (BWP), and occasion), terms for operations (e.g., step, method, process, and procedure), terms referring to data (e.g., information, parameter, variable, value, bit, symbol, and codeword), terms referring to channels, terms referring to control information (e.g., downlink control information (DCI), medium access control codeword element (MAC CE), and radio access control (RRC) signaling), terms referring to network entities, terms referring to device elements, and the like are illustratively used for the sake of descriptive convenience. Therefore, the disclosure is not limited by the terms as described below, and other terms referring to subjects having equivalent technical meanings may be used.

Various embodiments are described herein in connection with a wireless terminal and/or a base station. A wireless terminal may refer to a device providing voice and/or data connectivity to a user. The wireless terminal may be connected to a computing device such as a laptop computer or desktop computer, or it can be a self—contained device such as a personal digital assistant (PDA). The wireless terminal may also be called a system, a subscriber unit, a subscriber station, mobile station, mobile, remote station, access point, remote terminal, access terminal, user terminal, user agent, user device, or user equipment. The wireless terminal may be a subscriber station, a wireless device, a cellular telephone, a PCS telephone, a cordless telephone, a session initiation protocol (SIP) phone, a wireless local loop (WLL) station, a personal digital assistant (PDA), a handheld device having wireless connection capability, or other processing device connected to a wireless modem. A base station (e.g., access point) may refer to a device in an access network that communicates over the air-interface, through one or more sectors, with wireless terminals. The base station may act as a router between the wireless terminal and the rest of the access network, which can include an Internet Protocol (IP) network, by converting received air-interface frames to IP packets. The base station also coordinates management of attributes for the air interface.

In an orthogonal frequency division multiplexing (OFDM)-based wireless communication system, in order to estimate a phase error, a common phase error (CPE) that commonly affects all OFDM subcarriers should be estimated and compensated for using a reference signal in the frequency domain. In addition, the impact of inter-carrier interference (ICI) may be reduced by estimating and compensating for a phase error in units of symbols using a cyclic prefix (CP) in the time domain.

In 3rd Generation Partnership Project (3GPP) long-term evolution (LTE) and new radio (NR) systems, a demodulation reference signal (DMRS) may be inserted in the time domain and the frequency domain. A DMRS may be inserted by skipping one or more OFDM symbols in the time domain. When it is assumed that a wireless channel does not change, channel estimation may be performed, for channel estimation of an OFDM symbol in which no DMRS has been inserted, by performing linear interpolation or extrapolation on a neighboring OFDM symbol in which a DMRS has been inserted.

In 3GPP, a frequency band range from 24.25 GHz to 52.6 GHz is defined as frequency range (FR) 2. When 5G communication is performed using a frequency corresponding to FR2, phase noise (PN) may occur mainly on a UE side rather than a base station side. In this case, even if a wireless channel does not change, a channel between different OFDM symbols may appear different at a reception end due to phase noise. In addition, in a channel that changes slowly over time, channel estimation may be performed in an OFDM in which no DMRS exists, by performing linear interpolation or extrapolation of the channel in a neighboring OFDM in which a DMRS exists, but previously assumed linear characteristics may no longer be valid due to phase noise. Therefore, a PTRS may be inserted to enable a receiver to perform channel estimation more accurately in an OFDM symbol in which no DMRS exists. A PTRS is a training signal for estimating and compensating for phase distortion due to phase noise, the Doppler effect, or a synchronization error.

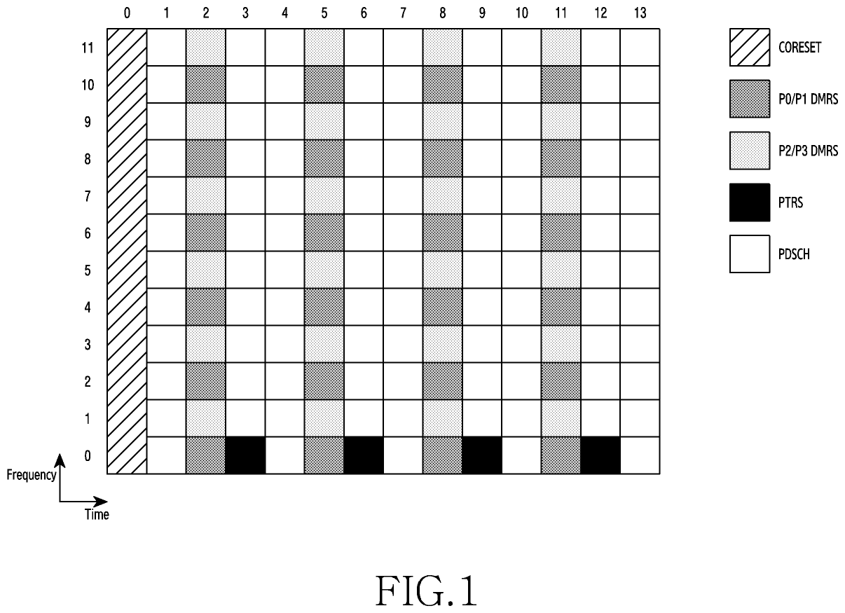

FIG. 1 is a diagram illustrating resource elements (REs) to which a phase tracking reference signal (PTRS) has been assigned in a wireless communication system according to various embodiments.

Referring to FIG. 1, the horizontal axis represents the time domain, and the vertical axis represents the frequency domain. The smallest unit in the time domain is an OFDM symbol, and the smallest unit in the frequency domain is a subcarrier. The basic unit of resources in the time-frequency domain is a resource element (RE), and may be indicated using an OFDM symbol index and a subcarrier index. 14 OFDM symbols may include 1 slot, and 12 subcarriers may include 1 resource block (RB).

FIG. 1 illustrates radio resources to which multiple different types of signals are assigned. Referring to FIG. 1, when there is 1 slot including 14 OFDM symbols, OFDM symbol index 0 (or OFDM symbol index 0, 1) may be allocated for a control resource set (CORESET). A physical downlink control channel (PDCCH) transmitted on a CORESET may include downlink control information (DCI) for scheduling of a physical downlink shared channel (PDSCH).

In FIG. 1, it is assumed that all DMRS ports 0/1/2/3 form the same DMRS port group. At P0/P1 DMRS locations, P0 DMRS and P1 DMRS having different orthogonal cover codes (OCCs) in the frequency domain may overlap. In addition, at P2/P3 DMRS locations, P2 DMRS and P3 DMRS having different OCCs in the frequency domain may overlap. For channel estimation in a radio resource, in which no DMRS exists, in FR2 where significant phase noise exists, a PTRS may be transmitted on a subcarrier corresponding to a specific DMRS antenna port within a resource block (RB). In FIG. 1, for example, the PTRS may be disposed in a resource element (RE) having no CORESET and no DMRS on a subcarrier with an index of 0.

PTRSs are disposed at locations (e.g., subcarriers) on the frequency axis of REs where a DMRS exists. The PTRSs may be disposed at predetermined intervals on the time axis, rather than being disposed in respective OFDM symbols. FIG. 1 illustrates an embodiment in which a PTRS is disposed at an interval of two OFDM symbols (e.g., an embodiment in which a PTRS is disposed at each group of three OFDM symbols), but the disclosure is not limited thereto, and PTRSs disposed on a single subcarrier may be disposed at an interval of an integer number of OFDM symbols.

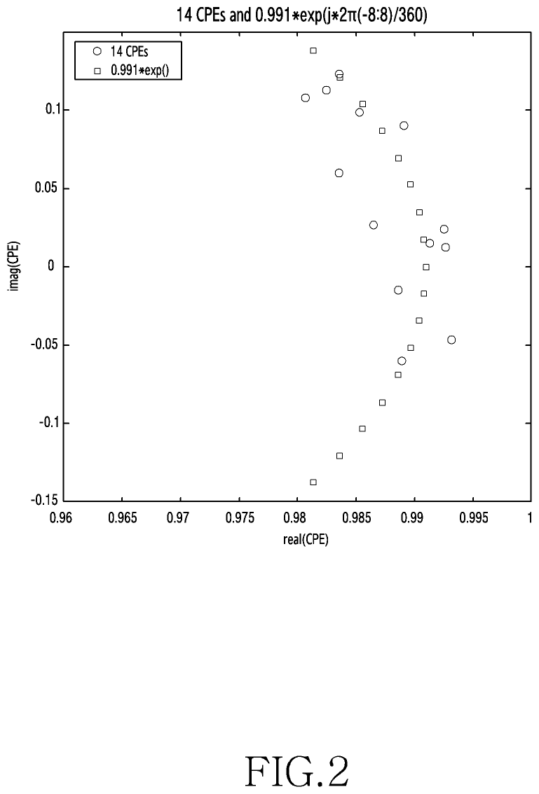

FIG. 2 is a graph illustrating a common phase error (CPE) according to various embodiments.

Phase noise (PN) generated in the time domain during signal transmission and reception may give the same gain to a reception signal of any RE within OFDM symbols in the frequency domain, and generate inter-carrier interference (ICI) while rotating the same phase. In this case, a variable of the same gain and the same phase may be referred to as a common phase error (CPE).

Referring to FIG. 2, the horizontal axis of a graph shows real number indexes of CPEs, and the vertical axis shows imaginary number indexes of CPEs. The graph shows dots, in which CPE gain is 0.991, at 1° intervals between phases −8° and 8°. In addition, the graph shows a constellation of 14 CPEs corresponding to 14 OFDM symbols.

The dots indicating 14 CPEs corresponding to 14 OFDM symbols may have phase values irregularly distributed between −8° and 8°, and may have the CPE gain that is approximately 1. Since the 14 CPE values corresponding to 14 OFDM symbols are irregularly distributed, it is necessary to estimate a CPE angle difference and apply an estimated value of the CPE angle difference to channel estimation.

Hereinafter, contents related to the contents described above are defined using equations and parameters. Signal yₙ[m] received in OFDM symbol n and sample m may be expressed as in <Equation 1> below.

$${y}_{n} [ m ] = {e}^{j {θ}_{n} [ m ]} {\sum }_{l ϵℒ} {h}_{n} [ l ] {x}_{n} [ {( m - l )}_{M} ] + {w}_{n} [ m ] \qquad [ Equation 1 ]$$

In Equation 1, θₙ[m] is PN in OFDM symbol n and sample m, [symbol] is a set of delays when a channel impulse response (CIR) has nonzero power at a specific delay, hₙ[l] is a CIR corresponding to delay l in OFDM symbol n, xₙ[m] is a transmission signal in OFDM symbol n and sample m, ( )_{M} is a modulo M operator, and Wₙ[m] denotes noise in OFDM symbol n and sample m.

If time domain reception signal yₙ[m] is converted to frequency domain signal ρₙ[k], <Equation 2> below may be derived.

$${ρ}_{n} [ k ] = {\underbrace{{ϕ}_{n} {η}_{n} [ k ]}}_{{=}^{Δ} {η′}_{n} [ k ]} {χ}_{n} [ k ] + {ω}_{n}^{′} [ k ] \qquad [ Equation 2 ]$$

In Equation 2, Øn is a CPE, nₙ[k] is a CFR at OFDM symbol n and frequency k, χₙ[k] is a frequency domain transmission signal at OFDM symbol n and frequency k, and ω′ₙ[k] denotes noise and an interference signal at OFDM symbol n and frequency k.

In <Equation 2>, CPE θₙ may be expressed approximately as in <Equation 3>.

$${ϕ}_{n} = \frac{1}{M} {\sum }_{m} {e}^{j {θ}_{n} [ m ]} \approx 1 + j \frac{1}{M} {\sum }_{m} {θ}_{n} [ m ] \approx {e}^{j {θ}_{n}} \qquad [ Equation 3 ]$$

In <Equation 3>, θₙ is defined as a CPE angle in OFDM symbol n. Therefore, in Equation 2, η′ₙ[k] may be interpreted as a CFR rotated at frequency k in OFDM symbol n.

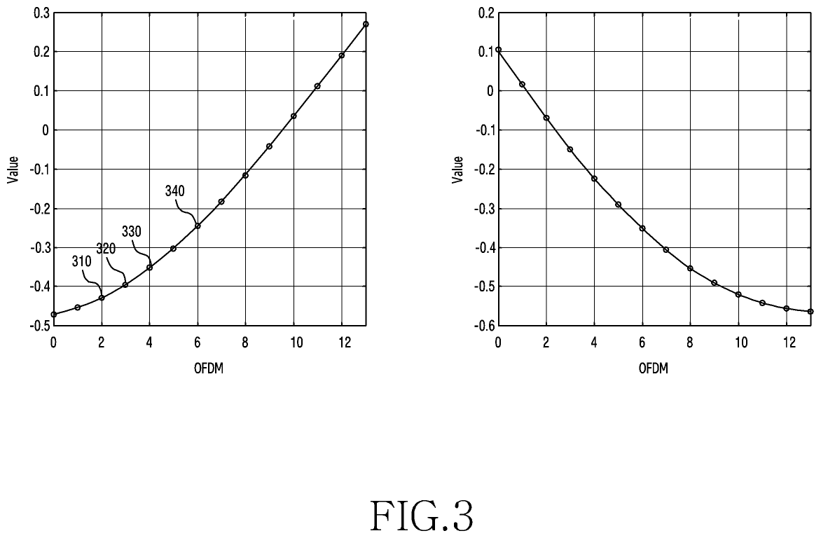

As shown in FIG. 3, when estimating a rotated CFR in an OFDM symbol where a DMRS does not exist and a PTRS exists, the CFR may be estimated by copying a pre-estimated and rotated CFR in a neighboring OFDM symbol having a DMRS, estimating a CPE angle difference using the PTRS, and then rotating the copied rotated CFR by the CPE angle difference.

Existing channel estimation for a PTRS RE may be described as follows. η′ₙ_{ᵥ}_{,0,n}_{ᵣ}[ƒ_{ū}] is assumed to be a rotated CFR estimate at transmission port 0, reception antenna nᵣ, OFDM symbol nᵥ where a DMRS exists, and frequency ƒ_{ū}. Since no DMRS exists in RE o_{v̅} where a PTRS exists, a reception end is unable to directly obtain a rotated CFR estimate for the PTRS RE. Therefore, in order to obtain a rotated CFR estimate at RE (PTRS RE) o_{v̅} where a PTRS exists and frequency ƒ_{ū} where the PTRS RE exists, the reception end first obtains a rotated CFR estimate of DMRS RE n_{v̅} close to PTRS RE OF. υₒ_{_{v̅}}_{,n}_{_{v̅}}[ƒ_{ū}] is assumed to be a reception signal at reception antenna nᵣ, OFDM symbol o_{v̅e̅} where a PTRS exists, and frequency ƒ_{ū} where the PTRS RE exists. Then, estimate θₒ_{_{v̅}}_{,n}_{_{v̅}} of a CPE angle difference between OFDM symbol o_{v̅e̅} and OFDM symbol n_{v̅} may be obtained as shown in <Equation 4> below.

$${\hat{θ}}_{{o}_{\overline{v}} , {n}_{v}} = ∠ {\sum }_{{n}_{r}} {v}_{{o}_{\overline{v}} , {n}_{r}} [ {f}_{\overline{u}} ] {( {{\hat{η}}^{′}}_{{n}_{v} , 0 , {n}_{r}} [ {f}_{\overline{u}} ] )}^{*} \qquad [ Equation 4 ]$$

In <Equation 4>, it has been assumed that a transmission end and a reception end has agreed to transmit a PTRS at port 0 of the transmission end, where Z is an angle operator, and * is a conjugate operator. Then, a rotated CFR estimate in OFDM symbol o_{v̅e̅} where no DMRS exists and a PTRS exists may be obtained as shown in <Equation 5> below.

$${{\hat{η}}^{′}}_{{o}_{\overline{v}} , {n}_{t} , {n}_{r}} [ k ] = {e}^{j {\hat{θ}}_{{o}_{\overline{v}} , {n}_{v}}} {{\hat{η}}^{′}}_{{n}_{v} , {n}_{t} , {n}_{r}} [ k ] \qquad [ Equation 5 ]$$

In <Equation 5>, \hat{η}′ₙ_{_{v̅}}_{,n}_{ₜ}_{,n}_{ᵣ}[k] denotes a rotated CFR estimate at OFDM symbol nᵥ having a DMRS, which is close to OFDM symbol o_{v̅}, frequency k, transmission port nₜ, and reception antenna nᵣ.

FIG. 3 includes graphs illustrating a channel frequency response (CFR) according to various embodiments. FIG. 3 illustrates changes of CFRs at frequency index 0 (e.g., an RE having subcarrier index 0 in FIG. 1) of 14 OFDM symbols when a carrier frequency is 28 GHz, a subcarrier spacing (SCS) is 60 KHz, and a receiver rate is 50 km/h, and shows a change graph of a CFR real number part and a change graph of a CFR imaginary part.

Referring to FIG. 3, CFRs show the form of a second-order parabolic function throughout the entire interval of 14 OFDM symbols, but may show the form of a first-order linear function approximately within an interval of 2 or 3 OFDM symbols.

In a wireless channel environment that changes over time, when estimating a channel in an RE to which a phase tracking reference signal (PTRS) has been assigned (e.g., an RE to which no DMRS has been assigned), if only a CFR estimate of one closest symbol to which a DMRS has been assigned is used according to a conventional scheme, a large error may occur in the channel estimation.

According to various embodiments of the disclosure, in order to reduce the error of the channel estimation described above, two symbols to which a DMRS has been assigned, which are close to the RE to which the PTRS has been assigned may be linearly interpolated or extrapolated, thereby acquiring a rotated CFR estimate in the RE to which the PTRS has been assigned. For example, in FIG. 3, if CFR values are unknown for cases where there are a CFR value of 310 for an OFDM symbol index of 2, a CFR value of 330 for an OFDM symbol index of 4, a CFR value of 320 for a symbol index of 3, and a CFR value of 340 for a symbol index of 6, then the CFR value of 320 for the index of 3 may be estimated by performing linear interpolation on the CFR value of 310 for the symbol index of 2 and the CFR value of 330 for the symbol index of 4, and the CFR value of 340 for the symbol index of 6 may be estimated by performing linear extrapolation on the CFR value of 310 for the symbol index of 2 and the CFR value of 330 for the symbol index of 4.

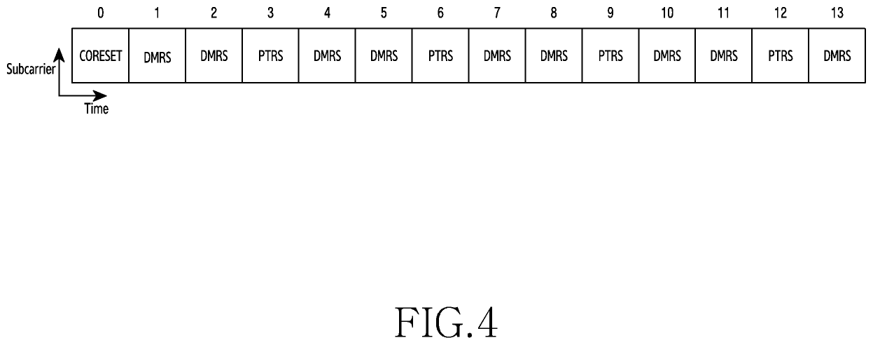

FIG. 4 is a diagram illustrating OFDM symbols in a specific subcarrier along the time axis according to various embodiments.

Referring to FIG. 4, the horizontal axis represents the time domain, and the vertical axis represents the frequency domain. The basic unit of resources in the time-frequency domain is a resource element (RE), in which the horizontal axis may be indicated using OFDM symbol indexes and the vertical axis may be indicated using subcarrier indexes. FIG. 4 illustrates 14 OFDM symbols, e.g., 14 REs, for a specific subcarrier.

PTRSs are disposed at locations (e.g., subcarriers) on the frequency axis of an RE where a DMRS exists. The PTRSs may be disposed at predetermined intervals on the time axis, rather than being disposed in every OFDM symbol. For example, FIG. 4 illustrates an embodiment in which the PTRSs are disposed at an interval of two OFDM symbols in RE 3, RE 6, RE 9, and 12, but the disclosure is not limited thereto, and the PTRSs disposed on a single subcarrier may be disposed at an interval of an integer number of OFDM symbols.

According to an embodiment of the disclosure, a UE may perform one-dimensional rotated CFR estimation for each RE where a DMRS exists. Subsequently, the UE may select CFR estimates of two REs where a DMRS exists (hereinafter, DMRS REs), the REs being close to an RE where a PTRS exists (hereinafter, a PTRS RE). The UE may acquire a first CFR estimate, which is a temporary CFR estimate of the PTRS RE, by performing linear interpolation on the selected CFR estimates of the two DMRS REs. According to various embodiments of the disclosure, the first CFR estimate may be acquired by performing linear extrapolation as well as linear interpolation on the two selected CFR estimates.

According to various embodiments of the disclosure, the first CFR estimate may be acquired based on DMRS REs that are close to the PTRS RE in the time domain. The DMRS REs may be the two REs that are closest to the PTRS RE in the time domain. For example, a first CFR estimate of PTRS RE 3 may be acquired based on RE 2 and RE 4 which are DMRS REs closest to RE 3 in the time domain. In this case, the DMRS REs close to the PTRS RE may refer to the two REs closest to the PTRS RE in time domain, but are not limited to this embodiment. The DMRS REs closest to the PTRS RE may be defined to include one RE closest to the PTRS RE in the forward direction and one RE closest to the PTRS RE in the backward direction in time domain, and may be defined to include one RE closest to the PTRS RE in the forward direction (or backward direction) and one RE second closest to the PTRS RE in time domain.

According to various embodiments of the disclosure, the UE may calculate an estimate of a common phase error (CPE) angle difference for the PTRS RE. The UE may acquire a second CFR estimate by applying the estimate of the CPE angle difference to the first CFR estimate acquired according to the procedure described above. The UE may perform phase tracking of the RE to which the PTRS has been assigned, based on the acquired second CFR estimate. In the example of FIG. 4, the UE may calculate the estimate of the CPE angle difference for RE 3 to which the RTRS has been assigned, and acquire the second CFR estimate for RE 3 by applying the estimate of the CPE angle difference to the first CFR estimate acquired based on RE 2 and RE 4.

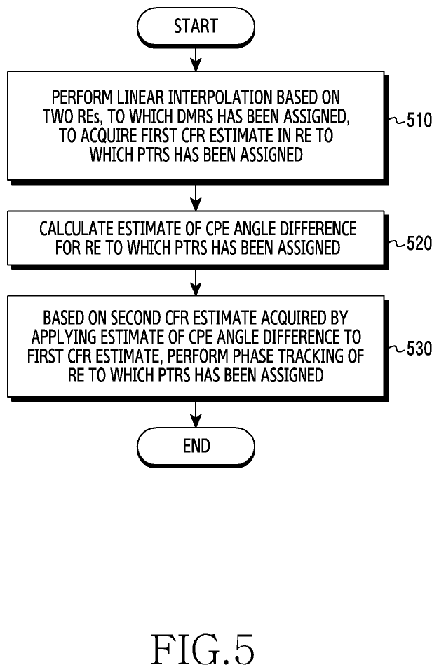

FIG. 5 is a flowchart illustrating an example channel estimation operation of a UE according to various embodiments.

The channel estimation operation of the UE illustrated in FIG. 5 may be performed based on a DMRS and a PTRS, e.g., downlink signals, received by the UE from a base station.

Referring to FIG. 5, in operation 510, a UE may perform linear interpolation based on two REs, to which a DMRS has been assigned, to acquire a first CFR estimate in an RE to which a PTRS has been assigned.

The UE may perform one-dimensional rotated CFR estimation in REs where a DMRS exists, and then select CFR estimates of the two REs where the DMRS exists, which are close to the RE where the PTRS exists. The UE may perform linear interpolation on the two selected CFR estimates so as to acquire a first CFR estimate (or a first CFR estimation value) which is a temporary CFR estimate of the RE where the PTRS exists. According to various embodiments of the disclosure, the first CFR estimate may be acquired by performing linear extrapolation as well as linear interpolation on the two selected CFR estimates.

According to various embodiments of the disclosure, the first CFR estimate may be acquired based on the REs to which the DMRS has been assigned, which are close in the time domain to the RE to which the PTRS has been assigned. The REs to which the DMRS has been assigned may be two REs closest in the time domain to the RE to which the PTRS has been assigned. For example, in FIG. 4, the first CFR estimate of RE 3 that is the RE to which the PTRS has been assigned may be acquired based on RE 2 and RE 4 which are two REs closest to RE 3 among the REs (RE 1, RE 2, RE 4, and RE 5) to which the DMRS has been assigned, which are close to RE 3 in the time domain.

In operation 520, the UE may calculate an estimate of a common phase error (CPE) angle difference for the RE to which the PTRS has been assigned. The UE may filter receptions signals of frequencies, where the RE having the PTRS exists, using a whitened matched filter in the spatial domain. The CPE angle difference may be estimated by accumulating result values of the filtering in the whitened matched filter.

According to various embodiments of the disclosure, when a rotated CFR estimate obtained at transmission port 0, reception antenna nᵣ, OFDM symbol nᵥ₊₁ where a DMRS exists, and frequency ƒ_{ū} is referred to as \hat{η}′ₙ_{ᵥ₊₁}_{,0,n}_{ᵣ}[ƒ_{ū}], and a first CFR estimate obtained by performing linear interpolation or linear extrapolation with \hat{η}′ₙ_{ᵥ}_{,0,n}_{ᵣ}[ƒ_{ū}] and \hat{η}′ₙ_{ᵥ₊₁}_{,0,n}_{ᵣ}[ƒ_{ū}] in OFDM symbol OF where the PTRS exists is referred to as ñ′ₒ_{_{v̅}}_{,0,n}_{ᵣ}[ƒ_{ū}], a vector obtained by collecting first CFR estimates across Nᵣ reception antennas may be as shown in <Equation 6> below.

$${{\tilde{η}}^{′}}_{{o}_{\overline{v}} , 0} [ {f}_{\overline{u}} ] = {[ {{\tilde{η}}^{′}}_{{o}_{\overline{v}} , 0 , 1} [ {f}_{\overline{u}} ] … {{\tilde{η}}^{′}}_{{o}_{\overline{v}} , 0 , {N}_{r}} [ {f}_{\overline{u}} ] ]}^{T} \qquad [ Equation 6 ]$$

The vector obtained by collecting reception signals υₒ_{ᵥ}_{,n}_{ᵣ}[ƒ_{ū}] across Nᵣ reception antennas at frequency ƒ_{ū} where the RE to which the PTRS exists may be as shown in <Equation 7> below.

$${v}_{{o}_{\overline{v}}} [ {f}_{\overline{u}} ] = {[ {v}_{{o}_{\overline{v}} , 1} [ {f}_{\overline{u}} ] … {v}_{{o}_{\overline{v}} , {N}_{r}} [ {f}_{\overline{u}} ] ]}^{T} \qquad [ Equation 7 ]$$

The estimate of the CPE angle difference may be obtained using ñ′ₒ_{_{v̅}}_{,0}[ƒᵤ] and υₒ_{_{v̅}}[ƒ_{ū}], and the estimate of the CPE angle difference is as shown in <Equation 8> below.

$${\hat{θ}}_{{o}_{\overline{v}}} = ∠ {\sum }_{\overline{u}} {( {\tilde{η}}_{{o}_{\overline{v}} , 0}^{′} [ {f}_{\overline{u}} ] )}^{H} {C}_{{o}_{\overline{v}}}^{- 1} [ {f}_{\overline{u}} ] {υ}_{{o}_{\overline{v}}} [ {f}_{\overline{u}} ] \qquad [ Equation 8 ]$$

Cₒ_{ᵥ}⁻¹[ƒᵤ] denotes an inverse matrix of estimation values of a covariance matrix showing a correlation of noises of reception antenna nᵣ at OFDM symbol o_{v̅} and frequency ƒ_{ū} across the reception antennas.

In operation 530, the UE may acquire a second CFR estimate by applying the estimate of the CPE angle difference to the first CFR estimate.

According to various embodiments of the disclosure, the second CFR estimate which is a rotated CFR estimate in the RE where the PTRS exists is as shown in <Equation 9> below.

$${\hat{η}}_{{o}_{\overline{v}} , {n}_{t} , {n}_{r}}^{′} [ k ] = {e}^{j {\hat{θ}}_{{o}_{\overline{v}}}} {\tilde{η}}_{{o}_{\overline{v}} , {n}_{t} , {n}_{r}}^{′} [ k ] \qquad [ Equation 9 ]$$

nₜ denotes the transmission port, nᵣ denotes the reception antenna, and op denotes the RE where the PTRS exists.

The UE may perform phase tracking of the RE to which the PTRS has been assigned, based on the acquired second CFR estimate. The PTRS may be used not only for the purpose of removing phase noise via CPE estimation, but also for the purpose of channel estimation in the frequency domain by performing phase tracking. Due to this channel estimation, when a channel changes rapidly on the time axis, a channel estimation result can be efficiently compensated, and channel degradation that may occur in a high-frequency band can be minimized and/or reduced.

In the above, the disclosure has been described based on a downlink case in which the UE receives a DMRS and a PTRS from the base station, but the same procedure may be applied to an uplink case. That is, the operations described above may also be applied identically or similarly to an uplink case in which the base station receives a DMRS and a PTRS from the UE.

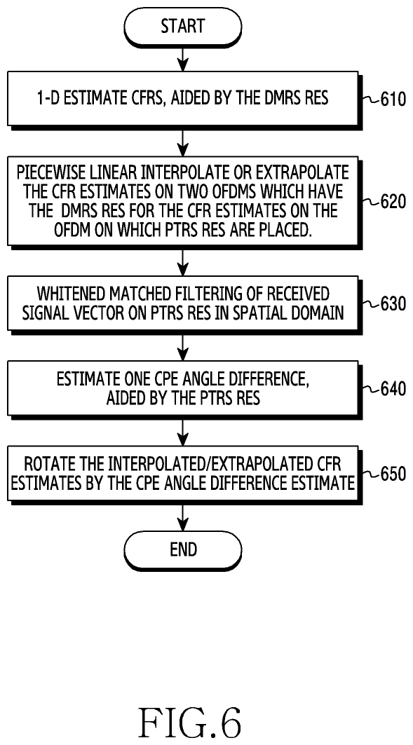

FIG. 6 is a flowchart illustrating an example channel estimation operation of a UE according to various embodiments. FIG. 6 illustrates the channel estimation operation of the UE of FIG. 5 in detail, and in FIG. 6, the overlapping contents described in FIG. 5 are omitted.

Referring to FIG. 6, in operation 610, a UE may perform one-dimensional rotated CFR estimation on an RE where a DMRS exists, so as to obtain a CFR estimate of the RE where the DMRS exists.

In operation 620, the UE may select CFR estimates of two REs where a DMRS exists, which are close to an RE where a PTRS exists, and perform linear interpolation or linear extrapolation on the two selected CFR estimates so as to acquire a first CFR estimate that is a temporary CFR estimate of the RE where the PTRS exists. According to various embodiments of the disclosure, the first CFR estimate may be acquired by performing linear extrapolation as well as linear interpolation on the two selected CFR estimates.

In operation 630, the UE may filter receptions signals of frequencies, where the RE having the PTRS exists, using a whitened matched filter in the spatial domain.

In operation 640, the UE may estimate a CPE angle difference by accumulating result values of the filtering in the whitened matched filter.

In operation 650, the UE may acquire a second CFR estimate by rotating, with the CPE angle difference estimate, the first CFR estimate for the RE where the PTRS exists. The UE may perform phase tracking of the RE to which the PTRS has been assigned, based on the acquired second CFR estimate.

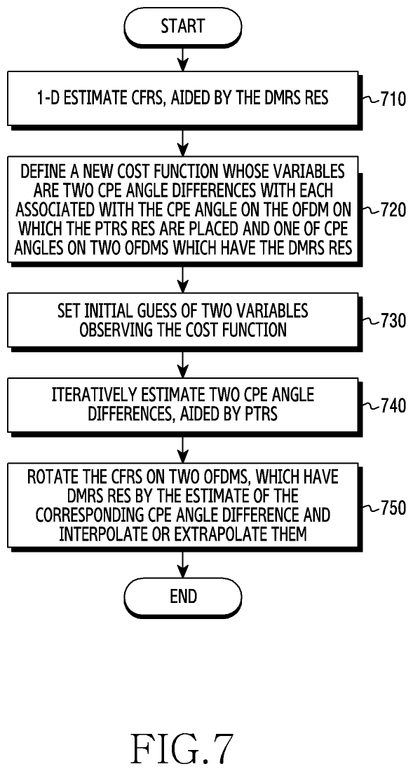

FIG. 7 is a flowchart illustrating an example channel estimation operation of a UE according to various embodiments.

Referring to FIG. 7, in operation 710, a UE may perform one-dimensional rotated CFR estimation on an RE where a DMRS exists, so as to obtain a first CFR estimate of the RE where the DMRS exists.

In operation 720, the UE may define a cost function in which a difference of two CPE angles is a variable. The CPE angle difference that is the variable of the cost function may indicate a difference between a CPE angle of an RE where a PTRS exists and a CPE angle of one of two REs where a DMRS exists.

In operation 730, the UE may configure initial values (e.g., set initial guess) of CPE angle differences which are two variables of the cost function. The initial values of the CPE angle differences may be configured according to a pre-configured condition.

In operation 740, the UE may estimate the two CPE angle differences, based on the RE where the PTRS exists. The CPE angle differences may be estimated using an iterative algorithm on the configured initial values of the two variables of the cost function. The iterative algorithm may include, for example, the Levenberg-Marquardt (LM) algorithm.

In operation 750, based on estimates of the two estimated CPE angle differences, the UE may rotate CFR estimates of two OFDM symbols, respectively, with the corresponding CPE angle difference estimates (two first CFR estimates), the two OFDM symbols having a DMRS and being close to the PTRS in the time axis, and may acquire a second estimate via linear interpolation or linear extrapolation of the two first CFR estimates. Thereafter, the UE may perform phase tracking of the RE to which the PTRS has been assigned, based on the acquired second CFR estimate.

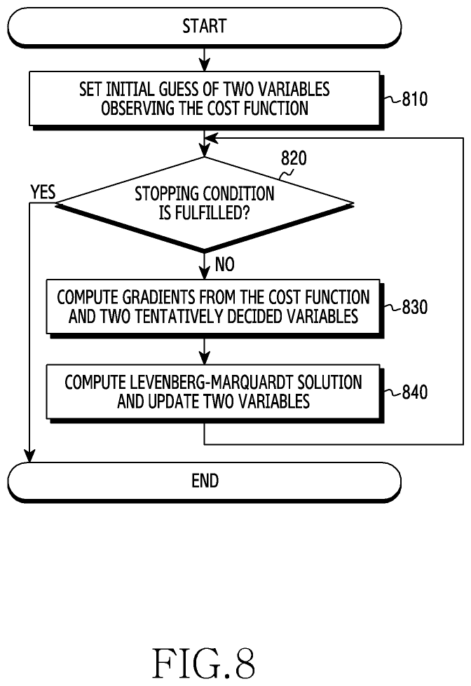

FIG. 8 is a flowchart illustrating an example channel estimation operation of a UE according to various embodiments. FIG. 8 illustrates an operation in which a UE estimates CPE angle differences, which are two variables of a cost function, using the iterative algorithm in operations 730 and 740 of FIG. 7.

In operation 810, the UE may configure initial values (e.g., set initial guess) of the CPE angle differences which are two variables of the cost function. The initial values of the CPE angle differences may be configured according to a pre-configured condition.

In operation 820, the UE determines whether a condition of stopping execution of the iterative algorithm used to obtain estimates of the CPE angle differences is satisfied. If the condition of stopping execution of the iterative algorithm is satisfied, the UE may stop repeated execution of the iterative algorithm and terminate the operation. If the condition of stopping execution of the iterative algorithm is not satisfied, the UE may perform an operation of operation 830.

In operation 830, the UE may calculate a gradient from tentative estimates of the two CPE angle differences and the cost function.

In operation 840, the UE may obtain estimates of new CPE angle differences by performing the Levenberg-Marquardt (LM) algorithm included in the iterative algorithm. The UE may update the estimates of the two new CPE angle differences which are variables of the cost function.

Hereinafter, a procedure of obtaining the CPE angle differences based on the cost function according to the example embodiments described in FIGS. 7 and 8 is described in detail. Hereinafter, the disclosure will be described based on a downlink case in which the UE receives a DMRS and a PTRS, but the same procedure may be applied to an uplink case. That is, the operations below may also be applied identically or similarly to an uplink case in which the base station receives a DMRS and a PTRS from the UE.

The UE performs one-dimensional rotated CFR estimation in DMRS REs, and the UE acquires a rotated CFR estimate for each of two DMRS REs close to a PTRS RE. Subsequently, in order to calculate CPE angle differences of the PTRS RE, the UE defines a cost function having two CPE angle differences as variables, and acquires two CPE angle difference values that minimize and/or reduce the cost function. In this way, in order to obtain two parameters that minimize and/or reduce the cost function, an iterative algorithm-based scheme may be used instead of a close form-based scheme, and the UE needs to determine initial values for performing this iterative algorithm scheme.

The UE obtains two whitened matched filter outputs in the space domain, with respect to two CFR estimates for two DMRS REs received on a subcarrier where the PTRS RE exists. The UE multiplies the two whitened matched filter outputs by a predetermined weight and acquires, respectively, two metrics accumulated over frequencies where the PTRS RE exists. In addition, the UE acquires one metric used to obtain correlation of vectors of the previously acquired rotated CFR estimates of the two DMRS REs. The UE may compare magnitudes of three metrics to determine the initial values of the two variables of the previously defined cost function.

When describing the example illustrated in FIG. 8 in greater detail, the UE may estimate CPE angle difference values for the two DMRS REs via repeated operations based on the LM algorithm. In this procedure, the UE may repeatedly perform updating of the two variables, based on a matrix obtained by partially differentiating the cost function, and may acquire the CPE angle difference values for the two DMRS REs via these repeated operations. In addition, the UE applies the CPE angle difference values to the rotated CFR estimates for the two respective DMRS REs, and then estimates a rotated CFR of the PTRS RE via a linear weighted sum.

Contents illustrated in FIG. 7 and FIG. 8 are described in more detail via equations below. The cost function may be expressed as <Equation 10> below.

$$C ( θ ) = \vert {Λ}_{2} \vert cos ( {∠Λ}_{2} + {θ}_{0} - {θ}_{1} ) - \vert {Λ}_{0} \vert cos ( {∠Λ}_{0} - {θ}_{0} ) - \vert {Λ}_{1} \vert cos ( {∠Λ}_{1} - {θ}_{1} ) \qquad [ Equation 10 ]$$

In Equation 10, vector θ is θ=[θ₀, θ₁]^{T}, θ₀ is a CPE angle difference between OFDM symbol o_{v̅ and OFDM symbol n}ᵥ, and θ₁ denotes a CPE angle difference between OFDM symbol o_{v̅ and OFDM symbol n}_{v̅+1}. \hat{η}′ₙ_{ᵥ}_{,0,n}_{ᵣ}[ƒ_{ū}] is defined to be vector \hat{η}′ₙ_{ᵥ}_{,0,}[ƒ_{ū}]=[\hat{η}′ₙ_{ᵥ}_{,0,1}[ƒ_{ū}] . . . \hat{η}′ₙ_{ᵥ}_{,0,N}_{ᵣ}[ƒ_{ū}]]^{T} collected across Nᵣ reception antennas. \hat{η}′ₙ_{ᵥ₊₁}_{,0,n}_{ᵣ}[ƒ_{ū}] is defined to be vector \hat{η}′ₙ_{ᵥ₊₁}_{,0,}[ƒ_{ū}]=[\hat{η}′ₙ_{ᵥ₊₁}_{,0,1}[ƒ_{ū}] . . . \hat{η}′ₙ_{ᵥ₊₁}_{,0,N}_{ᵣ}[ƒ_{ū}]]^{T} collected across Nᵣ reception antennas.

Λ₀, Λ₁, and Λ₂ may be defined as shown in <Equation 11> to <Equation 16>, respectively.

$${Λ}_{0} [ {f}_{\overline{u}} ] = \frac{{n}_{v + 1} - {o}_{\overline{v}}}{{n}_{v + 1} - {n}_{v}} {\underbrace{{( {\hat{η}}_{{n}_{v} , 0 ,}^{′} [ {f}_{\overline{u}} ] )}^{H} {C}_{{o}_{\overline{v}}}^{- 1} [ {f}_{\overline{u}} ] {υ}_{{o}_{\overline{v}}} [ {f}_{\overline{u}} ]}}_{= Whitened matched filtering} \qquad [ Equation 11 ]$$

$${Λ}_{1} [ {f}_{\overline{u}} ] = \frac{{o}_{\overline{v}} - {n}_{v}}{{n}_{v + 1} - {n}_{v}} {\underbrace{{( {\hat{η}}_{{n}_{v + 1} , 0 ,}^{′} [ {f}_{\overline{u}} ] )}^{H} {C}_{{o}_{\overline{v}}}^{- 1} [ {f}_{\overline{u}} ] {υ}_{{o}_{\overline{v}}} [ {f}_{\overline{u}} ]}}_{= Whitened matched filtering} \qquad [ Equation 12 ]$$

$${Λ}_{2} [ {f}_{\overline{u}} ] = \frac{{n}_{v + 1} - {o}_{\overline{v}}}{{n}_{v + 1} - {n}_{v}} \frac{{o}_{\overline{v}} - {n}_{v}}{{n}_{v + 1} - {n}_{v}} {\underbrace{{( {\hat{η}}_{{n}_{v} , 0 ,}^{′} [ {f}_{\overline{u}} ] )}^{H} {C}_{{o}_{\overline{v}}}^{- 1} [ {f}_{\overline{u}} ] {\hat{η}}_{{n}_{v + 1} , 0 ,}^{′} [ {f}_{\overline{u}} ]}}_{= Correlation} \qquad [ Equation 13 ]$$

$${Λ}_{0} = {\sum }_{\overline{u}} {Λ}_{0} [ {f}_{\overline{u}} ] \qquad [ Equation 14 ]$$

$${Λ}_{1} = {\sum }_{\overline{u}} {Λ}_{1} [ {f}_{\overline{u}} ] \qquad [ Equation 15 ]$$

$${Λ}_{2} = {\sum }_{\overline{u}} {Λ}_{2} [ {f}_{\overline{u}} ] \qquad [ Equation 16 ]$$

Obtaining of initial value θ^{[0]} of vector θ may be accomplished via observation of the cost function in Equation 10. If there is no separate criterion in obtaining of the initial value of the cost function, there may be a case where an obtained predetermined value is a local minimum rather than a global minimum, so that a predetermined criterion is required to efficiently obtain the initial value. <Equation 17> may be applied to this initial value determination.

$$If \vert {Λ}_{0} \vert \geq \vert {Λ}_{1} \vert \geq \vert {Λ}_{2} \vert , {θ}^{[ 0 ]} = {[ ∠ {Λ}_{0} , {∠Λ}_{1} ]}^{T} \qquad [ Equation 17 ]$$

$$else if \vert {Λ}_{0} \vert \geq \vert {Λ}_{2} \vert \geq \vert {Λ}_{1} \vert , {θ}^{[ 0 ]} = {[ ∠ {Λ}_{0} , {∠Λ}_{0} + ∠ {Λ}_{2} \pm π ]}^{T}$$

$$else if \vert {Λ}_{1} \vert \geq \vert {Λ}_{2} \vert \geq \vert {Λ}_{0} \vert {θ}^{[ 0 ]} = {[ ∠ {Λ}_{1} - ∠ {Λ}_{2} \pm π , {∠Λ}_{1} ]}^{T}$$

$$else if \vert {Λ}_{1} \vert \geq \vert {Λ}_{0} \vert \geq \vert {Λ}_{2} \vert {θ}^{[ 0 ]} = {[ ∠ {Λ}_{0} , {∠Λ}_{1} ]}^{T}$$

$$else if \vert {Λ}_{2} \vert \geq \vert {Λ}_{0} \vert \geq \vert {Λ}_{1} \vert {θ}^{[ 0 ]} = {[ ∠ {Λ}_{0} , {∠Λ}_{0} + ∠ {Λ}_{2} \pm π ]}^{T}$$

$$else if \vert {Λ}_{2} \vert \geq \vert {Λ}_{1} \vert \geq \vert {Λ}_{0} \vert {θ}^{[ 0 ]} = {[ ∠ {Λ}_{1} - ∠ {Λ}_{2} \pm π , {∠Λ}_{1} ]}^{T}$$

If initial value θ^{[0]} of the cost function is determined according to <Equation 10> and <Equation 17>, the UE may obtain an estimate of vector θ via repeated execution, such as the LM algorithm.

First, the UE calculates a whitened version of rotated CFR vector \hat{η}′ₙ_{ᵥ}_{,0}[ƒ_{ū}] as shown in <Equation 18> below.

$${s}_{0} [ {f}_{\overline{u}} ] = \frac{{n}_{v + 1} - {o}_{\overline{v}}}{{n}_{v + 1} - {n}_{v}} {C}_{{o}_{\overline{v}}}^{- 1 / 2} [ {f}_{\overline{u}} ] {\hat{η}}_{{n}_{v} , 0}^{′} [ {f}_{\overline{u}} ] \qquad [ Equation 18 ]$$

Subsequently, the UE calculates a whitened version of rotated CFR vector \hat{η}′ₙ_{ᵥ₊₁}_{,0}[ƒ_{ū}] as shown in <Equation 19> below.

$${s}_{1} [ {f}_{\overline{u}} ] = \frac{{o}_{\overline{v}} - {n}_{v}}{{n}_{v + 1} - {n}_{v}} {C}_{{o}_{\overline{v}}}^{- 1 / 2} [ {f}_{\overline{u}} ] {η}_{{n}_{v + 1} , 0}^{′} [ {f}_{\overline{u}} ] \qquad [ Equation 19 ]$$

Subsequently, the UE calculates a whitened version of vector υoᵥ[ƒᵤ] received in the PTRS RE as shown in <Equation 20> below.

$$y [ {f}_{\overline{u}} ] = {C}_{{o}_{\overline{v}}}^{- 1 / 2} [ {f}_{\overline{u}} ] {υ}_{{o}_{\overline{v}}} [ {f}_{\overline{u}} ] \qquad [ Equation 20 ]$$

The UE defines function ƒ as shown in <Equation 21>,

$$f ( {s}_{0 , {n}_{r}} [ {f}_{\overline{u}} ] , {s}_{1 , {n}_{r}} [ {f}_{\overline{u}} ] , θ ) = {e}^{j {θ}_{0}} {s}_{0 , {n}_{r}} [ {f}_{\overline{u}} ] + {e}^{j {θ}_{1}} {s}_{1 , {n}_{r}} [ {f}_{\overline{u}} ] \qquad [ Equation 21 ]$$

Gradient J^{[n]} of function ƒ in an nth iteration may be expressed according to <Equation 22> and <Equation 23> below.

$${J}^{[ n ]} = [ \begin{matrix}{je}^{j {θ}_{0}^{[ n ]}} {s}_{0} [ {f}_{1} ] & {je}^{j {θ}_{1}^{[ n ]}} {s}_{1} [ {f}_{1} ] \\ {je}^{j {θ}_{0}^{[ n ]}} {s}_{0} [ {f}_{2} ] & {je}^{j {θ}_{1}^{[ n ]}} {s}_{1} [ {f}_{2} ] \\ ⋮ & ⋮ \\ {je}^{j {θ}_{0}^{[ n ]}} {s}_{0} [ {f}_{\overline{U}} ] & {je}^{j {θ}_{1}^{[ n ]}} {s}_{1} [ {f}_{\overline{U}} ]\end{matrix} ] ∈ {ℂ}^{{N}_{r} \overline{U} \times 2} \qquad [ Equation 22 ]$$

$$ℜ \{ {( {J}^{[ n ]} )}^{H} {J}^{[ n ]} \} = [ \begin{matrix}{P}_{0} & ℜ \{ Q \} \\ ℜ \{ Q \} & {P}_{1}\end{matrix} ] \qquad [ Equation 23 ]$$

Parameters appearing in <Equation 22> and <Equation 23> may be defined according to <Equation 24> to <Equation 26> below.

$${P}_{0} = {\sum }_{\overline{u}} {\sum }_{{n}_{r}} {\vert {s}_{0 , {n}_{r}} [ {f}_{\overline{u}} ] \vert}^{2} \qquad [ Equation 24 ]$$

$${P}_{1} = {\sum }_{\overline{u}} {\sum }_{{n}_{r}} {\vert {s}_{1 , {n}_{r}} [ {f}_{\overline{u}} ] \vert}^{2} \qquad [ Equation 25 ]$$

$$Q = {e}^{j ( {θ}_{0}^{[ n ]} - {θ}_{1}^{[ n ]} )} {\sum }_{\overline{u}} {\sum }_{{n}_{r}} {s}_{0 , {n}_{r}} [ {f}_{\overline{u}} ] {s}_{1 , {n}_{r}}^{*} [ {f}_{\overline{u}} ] \qquad [ Equation 26 ]$$

In addition, in <Equation 26>, s_{0,n}_{ᵣ}[ƒ_{ū}] is an n, th entry of vector s₀[ƒᵤ], s_{1,n}_{ᵣ}[ƒ_{ū}] is an nᵣth entry of vector s₁[ƒ_{ū}], and a relationship of <Equation 27> below may be defined in relation to Equation 23.

$$ℜ \{ {( {J}^{[ n ]} )}^{H} ( y - f ( {θ}^{[ n ]} ) ) \} = [ \begin{matrix}𝔍 \{ {T}_{0} \} + 𝔍 \{ Q \} \\ 𝔍 \{ {T}_{1} \} - 𝔍 \{ Q \}\end{matrix} ] \qquad [ Equation 27 ]$$

Parameters related to <Equation 27> may be defined as shown in <Equation 28> to <Equation 30> below.

$$f ( {θ}^{[ n ]} ) = {[ f ( {s}_{0 , 1} [ {f}_{1} ] , {s}_{1 , 1} [ {f}_{1} ] , {θ}^{[ n ]} ) … , \\ f ( {s}_{0 , {N}_{r}} [ {f}_{\overline{U}} ] , {s}_{1 , {N}_{r}} [ {f}_{U} ] , {θ}^{[ n ]} ) ]}^{T} ∈ {ℂ}^{{N}_{r} \overline{U} \times 1} \qquad [ Equation 28 ]$$

$${T}_{0} = {e}^{- j {θ}_{0}^{[ n ]}} {\sum }_{\overline{u}} {\sum }_{{n}_{r}} {s}_{0 , {n}_{r}}^{*} [ {f}_{\overline{u}} ] {y}_{{n}_{r}} [ {f}_{\overline{u}} ] \qquad [ Equation 29 ]$$

$${T}_{1} = {e}^{- j {θ}_{1}^{[ n ]}} {\sum }_{\overline{u}} {\sum }_{{n}_{r}} {s}_{1 , {n}_{r}}^{*} [ {f}_{\overline{u}} ] {y}_{{n}_{r}} [ {f}_{\overline{u}} ] \qquad [ Equation 30 ]$$

In the n+1th iteration (n≥0) according to the iterations described above, vector θ^{[n+1]} may be expressed as shown in <Equation 31> and <Equation 32> below.

$${θ}^{[ n + 1 ]} = {θ}^{[ n ]} + \overline{δ} ( {J}^{[ n ]} , {θ}^{[ n ]} ) \qquad [ Equation 31 ]$$

$$\hat{δ} ( {J}^{[ n ]} , {θ}^{[ n ]} ) = {( ℜ \{ {( {J}^{[ n ]} )}^{H} {J}^{[ n ]} \} )}^{- 1} ℜ \{ {( {J}^{[ n ]} )}^{H} ( y - f ( {θ}^{[ n ]} ) ) \}$$

Vector θ at the end of iteration is assumed to be θ=[θₒ_{_{v̅}}ₙ_{ᵥ},θₒ_{_{v̅}}ₙ_{ᵥ₊₁}]^{T}. Then, a rotated CFR estimate at transmission port nₜ, reception antenna nᵣ, OFDM symbol o_{v̅} where no DMRS exists but a PTRS exists, and frequency k may be calculated as shown in [Equation 33].

$${\hat{η}}_{{o}_{\overline{v}} , {n}_{t} , {n}_{r}}^{′} [ k ] = {e}^{j {\hat{θ}}_{{o}_{\overline{v}} , {n}_{v}}} \frac{{n}_{v + 1} - {o}_{\overline{v}}}{{n}_{v + 1} - {n}_{v}} {\hat{η}}_{{n}_{v} , {n}_{t} , {n}_{r}}^{′} [ k ] + {e}^{j {\hat{θ}}_{{o}_{\overline{v}} , {n}_{v + 1}}} \frac{{o}_{\overline{v}} - {n}_{v}}{{n}_{v + 1} - {n}_{v}} {\hat{η}}_{{n}_{v + 1} , {n}_{t} , {n}_{r}}^{′} [ k ] \qquad [ Equation 33 ]$$

In <Equation 33>, \hat{η}′ₙ_{ᵥ}_{,n}_{ₜ}_{,n}_{ᵣ}[k] is a rotated CFR estimate vector at transmission port nₜ, reception antenna nᵣ, OFDM symbol (or RE) nᵥ where a DMRS exists, and frequency k, and \hat{η}′ₙ_{ᵥ₊₁}_{,n}_{ₜ}_{,n}_{ᵣ}[k] is a rotated CFR estimate vector at transmission port nₜ, reception antenna nᵣ, OFDM symbol (or RE) nᵥ₊₁ where a DMRS exists, and frequency k.

When the CFR estimate vectors (or CFR estimation values) for the two DMRS REs are acquired, respectively, via the procedure described above, the UE may obtain rotated CFR values for the two DMRS REs by applying CPE angle differences to the two CFR estimate vectors, respectively. Subsequently, the UE may acquire a CFR value for the PTRS RE via linear interpolation or extrapolation of the rotated CFR values obtained for the two DMRS REs.

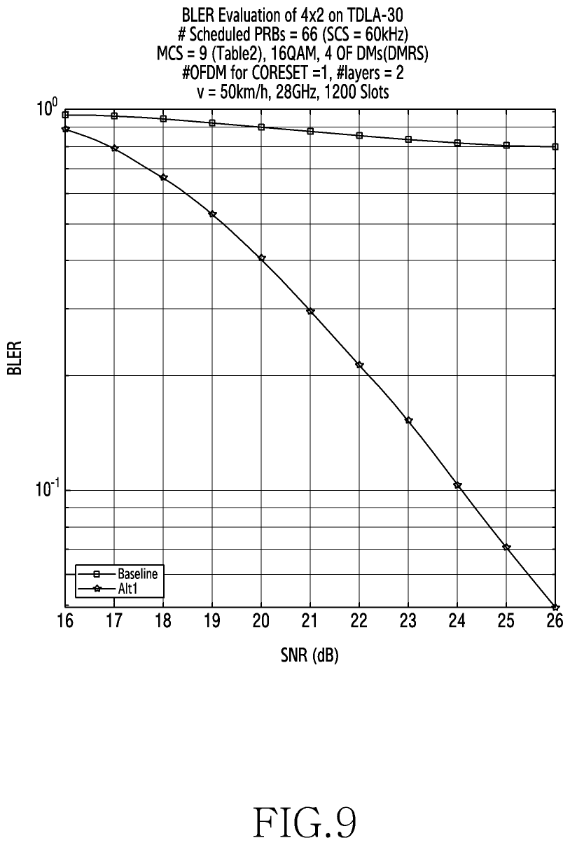

FIG. 9 is a graph illustrating BLER versus SNR according to various embodiments.

The graph in FIG. 9 shows BLER performance obtained via a 1200-slot Monte Carlo experiment when a carrier frequency of 28 GHz, 4×2 TDLA-30 channels, SCS=60 KHz, modulation and coding (MCS)=9, MCS table=2, 16-quadrature amplitude modulation (QAM), four REs where a DMRS exists, one RE for a CORESET, two PDSCH layers, and a rate of 50 km/h are satisfied. The horizontal axis of the graph represents a signal-noise ratio (hereinafter, SNR), and the vertical axis represents a block error rate (BLER).

In FIG. 9, the SNR-BLER graph shows the BLER versus the SNR for each of a case (baseline) where a CFR estimate in an RE to which a PTRS has been assigned is acquired using one RE to which a DMRS has been assigned, and a case (Alt 1) (e.g., the UE operation of FIG. 5) where a CFR estimate in an RE to which a PTRS has been assigned is acquired by performing linear interpolation or extrapolation using two REs to which a DMRS has been assigned.

Referring to FIG. 9, it may be seen that a decrease rate of the BLER is greater as the SNR increases in the case where a CFR estimate in an RE to which a PTRS has been assigned is acquired by performing linear interpolation or extrapolation using two REs to which a DMRS has been assigned, in comparison with the case where a CFR estimate in an RE to which a PTRS has been assigned is acquired using one RE to which an DMRS has been assigned. This shows that technology of acquiring a CFR estimate using two REs to which a DMRS has been assigned can have excellent reception performance in a high-frequency environment where a wireless channel environment changes over time and phase noise exists accordingly.

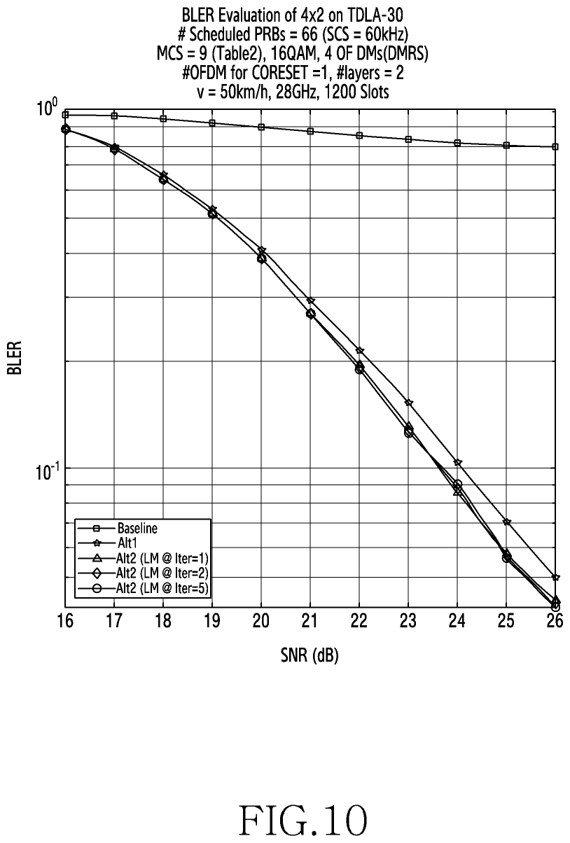

FIG. 10 is a graph illustrating block error rate (BLER) versus SNR according to various embodiments.

Referring to FIG. 10, the graph 1000 shows BLER performance obtained via a 1200-slot Monte Carlo experiment when a carrier frequency of 28 GHz, 4×2 TDLA-30 channels, SCS=60 KHz, modulation and coding (MCS)=9, MCS table=2, 16-quadrature amplitude modulation (QAM), four REs where a DMRS exists, one RE for a CORESET, two PDSCH layers, and a rate of 50 km/h are satisfied. The horizontal axis of the graph represents a signal-noise ratio (SNR), and the vertical axis represents a block error rate (BLER). The SNR-BLER graph in FIG. 10 includes the graph illustrated in FIG. 9.

In FIG. 10, the SNR-BLER graph shows the BLER versus the SNR for each of a case (baseline) where a CFR estimate in an RE to which a PTRS has been assigned is acquired using one RE to which a DMRS has been assigned, a case (Alt 1) (e.g., the UE operation of FIG. 5) where a CFR estimate in an RE to which a PTRS has been assigned is acquired by performing linear interpolation or extrapolation using two REs to which a DMRS has been assigned, and a case (Alt 2) (e.g., the UE operation of FIG. 7) where a CFR estimate is acquired by performing an iterative algorithm on a cost function having two CPE angle differences as variables using two REs to which a DMRS has been assigned.

Referring to FIG. 10, it may be seen that a decrease rate of the BLER is greater as the SNR increases in the case where a CFR estimate is acquired by performing an iterative algorithm on a cost function having two CPE angle differences as variables using two REs to which a DMRS has been assigned, in comparison with the case where a CFR estimate in an RE to which a PTRS has been assigned is acquired using one RE to which an DMRS has been assigned. This shows that technology of acquiring a CFR estimate using two REs to which a DMRS has been assigned can have excellent reception performance in a high-frequency environment where a wireless channel environment changes over time and phase noise exists accordingly.

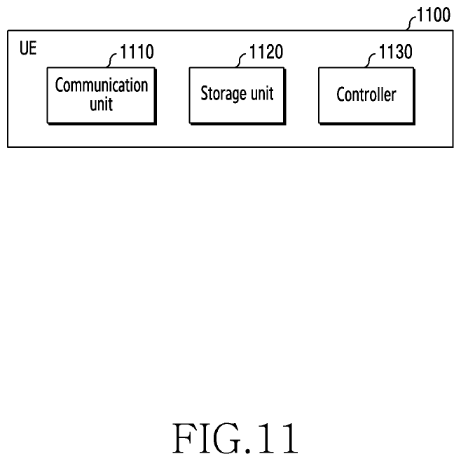

FIG. 11 is a block diagram illustrating an example configuration of a UE 1100 according to various embodiments.

The configuration illustrated in FIG. 11 may be understood as a configuration of the UE 1100. The terms “ . . . unit”, “ . . . device”, etc. used hereinafter refer to a unit configured to process at least one function or operation, and may be implemented as hardware, software, or a combination of hardware and software.

Referring to FIG. 11, the UE 1100 includes a communication unit (e.g., including communication circuitry) 1110, a storage unit (e.g., including memory) 1120, and a controller (e.g., including at least one processor including processing circuitry) 1130.

The communication unit 1110 may include various communication circuitry and performs functions for transmitting/receiving signals through a radio channel. For example, the communication unit 1110 performs functions of conversion between baseband signals and bitstrings according to the physical layer specifications of the system. For example, during data transmission, the communication unit 1110 generates complex symbols by encoding and modulating a transmission bitstream. In addition, during data reception, the communication unit 1110 demodulates and decodes a baseband signal to restore a received bitstring. In addition, the communication unit 1110 up-converts a baseband signal to an RF band signal, transmits the same through an antenna, and down-converts an RF band signal received through the antenna to a baseband signal. For example, the communication unit 1110 may include a transmission filter, a reception filter, an amplifier, a mixer, an oscillator, a DAC, and an ADC.

In addition, the communication unit 1110 may include multiple transmission/reception paths. Furthermore, the communication unit 1110 may include an antenna unit. The communication unit 1110 may include at least one antenna array configured by multiple antenna elements. In terms of hardware, the communication unit 1110 may include a digital circuit and an analog circuit (e.g., a radio frequency integrated circuit (RFIC)). The digital circuit and the analog circuit may be implemented as a single package. In addition, the communication unit 1110 may include multiple RF chains. The communication unit 1110 may perform beamforming. In order to assign directivity based on configurations of the controller 1130 to a signal to be transmitted/received, the communication unit 1110 may apply a beamforming weight to the signal. According to an embodiment, the communication unit 3110 may include a radio frequency (RF) block (or RF unit). The RF block may include a first RF circuitry related to antennas and a second RF circuitry related to baseband processing. The first RF circuitry may be referred to as an RF-A (antenna). The second RF circuitry may be referred to as an RF-B (baseband).

In addition, the communication unit 1110 may transmit/receive signals. To this end, the communication unit 1110 may include at least one transceiver. In addition, the communication unit 1110 may receive an uplink signal. The downlink signal may include a synchronization signal (SS), a reference signal (RS) (e.g., demodulation (DM)-RS or phase tracking reference signal (PTRS)), system information (e.g., MIB, SIB, remaining system information (RMSI), or other system information (OSI)), a configuration message, control information, downlink data, or the like. The communication unit 1110 may transmit a downlink signal. The uplink signal may include a random access-related signal (e.g., random access preamble (RAP) (or message 1 (Msg1), message 3 (Msg3)), a reference signal (e.g., sounding reference signal (SRS), DMRS, or PTRS), a power headroom report (PHR), or the like.

In addition, the communication unit 1110 may include different communication modules for processing signals in different frequency bands. Furthermore, the communication unit 1110 may include multiple communication modules in order to support multiple different radio access techniques. For example, the multiple different radio access techniques may include Bluetooth low energy (BLE), Wireless Fidelity (Wi-Fi), WiFi Gigabyte (WiGig), a cellurar network (e.g., long term evolution (LTE) or new radio (NR)), and the like. Also, the different frequency bands may include super high frequency (SHF) bands (e.g., 2.5 GHz or 5 GHz bands), millimeter wave (mmWave) bands (e.g., 38 GHz or 60 GHz bands), and the like. In addition, the communication unit 1110 may also use the same type radio access technique in different frequency bands (e.g., unlicensed bands for licensed assisted access (LAA) or citizens broadband radio service (e.g., 3.5 GHz)).

The communication unit 1110 transmits and receives signals as described above. Accordingly, all or part of the communication unit 1110 may be referred to as a “transmitter”, a “receiver”, or a “transceiver”. In addition, as used in the following description, the “transmission and reception performed through a radio channel” includes that the above-described processing is performed by the communication unit 1110.

The storage unit 1120 may include various memory and stores data, such as a basic program, an application program, and configuration information for operations of the UE 1100. The storage unit 1120 may include a volatile memory, a nonvolatile memory, or a combination of a volatile memory and a nonvolatile memory. In addition, the storage unit 1120 provides the stored data at the request of the controller 1130.

The controller 1130 may include at least one processor comprising various processing circuitry and controls overall operations of the UE 1100. For example, the controller 1130 transmits/receives signals through the communication unit 1110. In addition, the controller 1130 records data in the storage 1120 and reads the data from the storage 1120. In addition, the controller 1130 may perform functions of protocol stacks required by communication specifications. To this end, the controller 1130 may include at least one processor. The controller 1130 may include at least one processor or micro-processor, or may be a part of a processor. In addition, a part of the communication unit 1110 and the controller 1130 may be referred to as a communication processor (CP). The controller 1130 may include various modules for performing communication. According to various embodiments, the controller 1130 may control the UE to perform operations according to various embodiments. The at least one processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

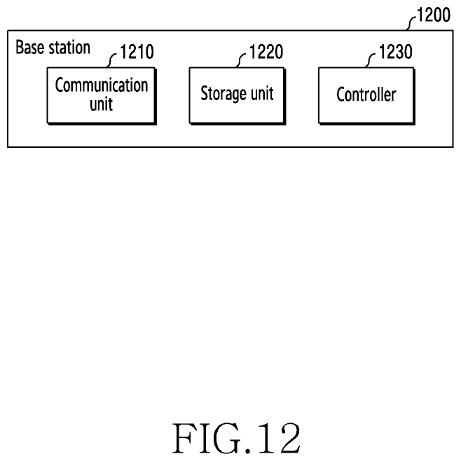

FIG. 12 is a block diagram illustrating an example configuration of a base station in a wireless communication system according to various embodiments.

Referring to FIG. 12, a base station 1200 includes a communication unit (e.g., including communication circuitry) 1210, a storage unit (e.g., including memory) 1220, and a controller (e.g., including at least one processor comprising processing circuitry) 1230.

The communication unit 1210 may include various communication circuitry and performs functions for transmitting/receiving signals through a radio channel. For example, the communication unit 1210 performs functions of conversion between baseband signals and bitstrings according to the physical layer specifications of the system. For example, during data transmission, the communication unit 1210 generates complex symbols by encoding and modulating a transmission bitstream. In addition, during data reception, the communication unit 1210 demodulates and decodes a baseband signal to restore a received bitstring. In addition, the wireless communication unit 1210 up-converts a baseband signal to a radio frequency (RF) band signal, transmits the up-converted RF band signal via an antenna, and then down-converts the RF band signal received via the antenna to a baseband signal.

To this end, the wireless communication unit 1210 may include a transmission filter, a reception filter, an amplifier, a mixer, an oscillator, a digital to analog converter (DAC), an analog to digital converter (ADC), and the like. In addition, the communication unit 1210 may include multiple transmission/reception paths. Furthermore, the wireless communication unit 1210 may include at least one antenna array including multiple antenna elements. In terms of hardware, the wireless communication unit 1210 may include a digital unit and an analog unit, and the analog unit may include multiple sub-units according to operation power, frequencies, etc.

The communication unit 1210 may transmit/receive signals. To this end, the communication unit 1210 may include at least one transceiver. For example, the communication unit 1210 may transmit a synchronization signal, a reference signal, system information, a message, control information, data, or the like. Furthermore, the communication unit 1210 may perform beamforming.

The communication unit 1210 transmits and receives signals as described above. Accordingly, all or part of the communication unit 1210 may be referred to as a “transmitter”, a “receiver”, or a “transceiver”. In addition, as used in the following description, the meaning of “transmission and reception performed through a radio channel” includes the meaning that the above-described processing is performed by the communication unit 1210.

The storage unit 1220 may include various memory and stores data such as basic programs, application programs, and configuration information for operations of the base station. The storage unit 1220 may include a memory. The storage unit 1220 may include a volatile memory, a nonvolatile memory, or a combination of a volatile memory and a nonvolatile memory. In addition, the storage unit 1220 provides the stored data at the request of the controller 1230.

The controller 1230 may include at least one processor comprising processing circuitry and controls the overall operation of the base station 1200. For example, the controller 1230 transmits/receives signals through the communication unit 1210. In addition, the controller 1230 records data in the storage 1220 and reads the data from the storage 230. Furthermore, the controller 1230 may perform functions of protocol stacks required by communication specifications. To this end, the controller 1230 may include at least one processor. The at least one processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The structure of the base station 1200 illustrated in FIG. 12 is a merely an example of the base station, and examples of the base station for performing various embodiment of the disclosure are not limited to the structure illustrated in FIG. 12. That is, some elements may be added, omitted, or changed according to various embodiments.

In FIG. 12, the base station 1200 has been described as a single entity, but the disclosure is not limited thereto. In addition to the integrated deployment, the base station 1200 according to various embodiments of the disclosure may be implemented to construct an access network having a distributed deployment. According to an embodiment, the base station may be divided into a central unit (CU) and a digital unit (DU), the CU may be implemented to perform upper layer functions (e.g., packet data convergence protocol (PDCP) and RRC), and the DU may be implemented to perform lower layer functions (e.g., medium access control (MAC) and physical (PHY)). The DU of the base station may form beam coverage on a radio channel.

The various example embodiments described and shown in the disclosure and the drawings are merely examples that have been presented to explain the technical contents of the disclosure and help understanding of the disclosure, and are not intended to limit the scope of the disclosure. It will be apparent to those skilled in the art that other variants based on the technical idea of the disclosure may be implemented. Also, the above respective embodiments may be employed in combination, as necessary.

As described above, a method for receiving a phase tracking reference signal (PTRS) by a UE (e.g., 1100 of FIG. 11) in a wireless communication system according to various example embodiments may include: performing linear interpolation based on two resource elements (REs) to which a demodulation reference signal (DMRS) has been assigned, to acquire a first CFR estimation value in an RE to which a PTRS has been assigned, calculating an estimation value of a CPE angle difference for the RE to which the PTRS has been assigned, and based on a second CFR estimation value acquired by applying the estimation value of the CPE angle difference to the first CFR estimation value, performing phase tracking of the RE to which the PTRS has been assigned.

According to various example embodiments, the estimation value of the CPE angle difference may be acquired by filtering a reception signal at a frequency, where the RE to which the PTRS has been assigned exists, using a whitened matched filter in the spatial domain, and accumulating a result value of the filtering in the whitened matched filter.

According to various example embodiments, the acquiring of the first CFR estimation value may include acquiring the first CFR estimation value based on the REs to which the DMRS has been assigned, the REs being close in the time domain to the RE to which the PTRS has been assigned, wherein the REs to which the DMRS has been assigned are two REs closest in the time domain to the RE to which the PTRS has been assigned.

According to various example embodiments, the two REs to which the DMRS has been assigned and the RE to which the PTRS has been assigned may be located within a physical downlink shared channel (PDSCH) resource. According to various example embodiments, the two REs to which the DMRS has been assigned and the RE to which the PTRS has been assigned may be located on the same subcarrier.

As described above, a UE for receiving a phase tracking reference signal (PTRS) in a wireless communication system according to various example embodiments may include: a transceiver and at least one processor, comprising processing circuitry, wherein at least one processor, individually and/or collectively, is configured to: perform linear interpolation based on two resource elements (REs) to which a demodulation reference signal (DMRS) has been assigned, thereby acquiring a first CFR estimation value in an RE to which a PTRS has been assigned, calculate an estimation value of a CPE angle difference for the RE to which the PTRS has been assigned, and based on a second CFR estimation value acquired by applying the estimation value of the CPE angle difference to the first CFR estimation value, perform phase tracking of the RE to which the PTRS has been assigned.

According to various example embodiments, at least one processor, individually and/or collectively, may be configured so that the estimation value of the CPE angle difference is acquired by filtering a reception signal at a frequency, where the RE to which the PTRS has been assigned exists, using a whitened matched filter in the spatial domain, and accumulating a result value of the filtering in the whitened matched filter.

According to various example embodiments, at least one processor, individually and/or collectively, may be configured so that the first CFR estimation value is acquired based on the REs to which the DMRS has been assigned, the REs being close in the time domain to the RE to which the PTRS has been assigned, wherein the REs to which the DMRS has been assigned are two REs closest in the time domain to the RE to which the PTRS has been assigned.

According to various example embodiments, the two REs to which the DMRS has been assigned and the RE to which the PTRS has been assigned may be located within a physical downlink shared channel (PDSCH) resource.

According to various example embodiments, the two REs to which the DMRS has been assigned and the RE to which the PTRS has been assigned may be located on the same subcarrier.

As described above, a method for receiving a phase tracking reference signal (PTRS) by a base station (e.g., 1200 of FIG. 12) in a wireless communication system according to various example embodiments may include: performing linear interpolation based on two resource elements (REs) to which a demodulation reference signal (DMRS) has been assigned, thereby acquiring a first CFR estimation value in an RE to which a PTRS has been assigned, calculating an estimation value of a CPE angle difference for the RE to which the PTRS has been assigned, and based on a second CFR estimation value acquired by applying the estimation value of the CPE angle difference to the first CFR estimation value, performing phase tracking of the RE to which the PTRS has been assigned.

According to various example embodiments, the estimation value of the CPE angle difference may be acquired by filtering a reception signal at a frequency, where the RE to which the PTRS has been assigned exists, using a whitened matched filter in the spatial domain, and accumulating a result value of the filtering in the whitened matched filter.

According to various example embodiments, the acquiring of the first CFR estimation value may include acquiring the first CFR estimation value based on the REs to which the DMRS has been assigned, the REs being close in the time domain to the RE to which the PTRS has been assigned, wherein the REs to which the DMRS has been assigned are two REs closest in the time domain to the RE to which the PTRS has been assigned.

According to various example embodiments, the two REs to which the DMRS has been assigned and the RE to which the PTRS has been assigned may be located within a physical uplink shared channel (PUSCH) resource.

According to various example embodiments, the two REs to which the DMRS has been assigned and the RE to which the PTRS has been assigned may be located on the same subcarrier.

As described above, a base station for receiving a phase tracking reference signal (PTRS) in a wireless communication system according to various example embodiments may include: a transceiver and at least one processor, comprising processing circuitry, wherein at least one processor, individually and/or collectively, is configured to: perform linear interpolation based on two resource elements (REs) to which a demodulation reference signal (DMRS) has been assigned, thereby acquiring a first CFR estimation value in an RE to which a PTRS has been assigned, calculate an estimation value of a CPE angle difference for the RE to which the PTRS has been assigned, and based on a second CFR estimation value acquired by applying the estimation value of the CPE angle difference to the first CFR estimation value, perform phase tracking of the RE to which the PTRS has been assigned.

According to various example embodiments, at least one processor, individually and/or collectively, may be configured so that the estimation value of the CPE angle difference is acquired by filtering a reception signal at a frequency, where the RE to which the PTRS has been assigned exists, using a whitened matched filter in the spatial domain, and accumulating a result value of the filtering in the whitened matched filter.

According to various example embodiments, at least one processor, individually and/or collectively, may be configured so that the first CFR estimation value is acquired based on the REs to which the DMRS has been assigned, the REs being close in the time domain to the RE to which the PTRS has been assigned, wherein the REs to which the DMRS has been assigned are two REs closest in the time domain to the RE to which the PTRS has been assigned.

According to various example embodiments, the two REs to which the DMRS has been assigned and the RE to which the PTRS has been assigned may be located within a physical uplink shared channel (PUSCH) resource.

According to various example embodiments, the two REs to which the DMRS has been assigned and the RE to which the PTRS has been assigned may be located on the same subcarrier.

What is claimed is:

1. A method for receiving a phase tracking reference signal (PTRS) by a user equipment in a wireless communication system, the method comprising:
performing linear interpolation based on two resource elements (REs) to which a demodulation reference signal (DMRS) has been assigned, to acquire a first channel frequency response (CFR) estimation value in an RE to which the PTRS has been assigned;
acquiring an estimation value of a common phase error (CPE) angle difference for the RE to which the PTRS has been assigned; and
based on a second CFR estimation value acquired by applying the estimation value of the CPE angle difference to the first CFR estimation value, performing phase tracking of the RE to which the PTRS has been assigned.

2. The method of claim 1, wherein the estimation value of the CPE angle difference is acquired by performing:
filtering a reception signal at a frequency, where the RE to which the PTRS has been assigned exists, using a whitened matched filter in the spatial domain; and
accumulating a result value of the filtering in the whitened matched filter.

3. The method of claim 1, wherein the acquiring of the first CFR estimation value comprises: acquiring the first CFR estimation value based on the REs to which the DMRS has been assigned, the REs being close in the time domain to the RE to which the PTRS has been assigned, and
wherein the REs to which the DMRS has been assigned are two REs closest in the time domain to the RE to which the PTRS has been assigned.

4. The method of claim 1, wherein the two REs to which the DMRS has been assigned and the RE to which the PTRS has been assigned are located within a physical downlink shared channel (PDSCH) resource.

5. The method of claim 1,
wherein the two REs to which the DMRS has been assigned and the RE to which the PTRS has been assigned are located on a same subcarrier.

6. A user equipment (UE) configured to receive a phase tracking reference signal (PTRS) in a wireless communication system, the terminal comprising:
a transceiver; and
a controller coupled with the transceiver and configured to:
perform linear interpolation based on two resource elements (REs) to which a demodulation reference signal (DMRS) has been assigned, to acquire a first channel frequency response (CFR) estimation value in an RE to which the PTRS has been assigned;
acquire an estimation value of a common phase error (CPE) angle difference for the RE to which the PTRS has been assigned; and
based on a second CFR estimation value acquired by applying the estimation value of the CPE angle difference to the first CFR estimation value, perform phase tracking of the RE to which the PTRS has been assigned.

7. The UE of claim 6, wherein the controller is further configured to acquire the estimation value of the CPE angle difference by performing:
filtering a reception signal at a frequency, where the RE to which the PTRS has been assigned exists, using a whitened matched filter in the spatial domain; and
accumulating a result value of the filtering in the whitened matched filter.

8. The UE of claim 6, wherein the controller is further configured to acquire the first CFR estimation value based on the REs to which the DMRS has been assigned, the REs being close in the time domain to the RE to which the PTRS has been assigned, and
wherein the REs to which the DMRS has been assigned are two REs closest in the time domain to the RE to which the PTRS has been assigned.

9. The UE of claim 6, wherein the two REs to which the DMRS has been assigned and the RE to which the PTRS has been assigned are located within a physical downlink shared channel (PDSCH) resource.

10. The UE of claim 6,
wherein the two REs to which the DMRS has been assigned and the RE to which the PTRS has been assigned are located on a same subcarrier.

11. A method for receiving a phase tracking reference signal (PTRS) by a base station (BS) in a wireless communication system, the method comprising:
performing linear interpolation based on two resource elements (REs) to which a demodulation reference signal (DMRS) has been assigned, to acquire a first channel frequency response (CFR) estimation value in an RE to which the PTRS has been assigned;
acquiring an estimation value of a common phase error (CPE) angle difference for the RE to which the PTRS has been assigned; and
based on a second CFR estimation value acquired by applying the estimation value of the CPE angle difference to the first CFR estimation value, performing phase tracking of the RE to which the PTRS has been assigned.

12. The method of claim 11, wherein the estimation value of the CPE angle difference is acquired by performing:
filtering a reception signal at a frequency, where the RE to which the PTRS has been assigned exists, using a whitened matched filter in the spatial domain; and
accumulating a result value of the filtering in the whitened matched filter.

13. The method of claim 11, wherein the acquiring of the first CFR estimation value comprises acquiring the first CFR estimation value based on the REs to which the DMRS has been assigned, the REs being close in the time domain to the RE to which the PTRS has been assigned,
wherein the REs to which the DMRS has been assigned are two REs closest in the time domain to the RE to which the PTRS has been assigned.

14. The method of claim 13, wherein the two REs to which the DMRS has been assigned and the RE to which the PTRS has been assigned are located within a physical uplink shared channel (PUSCH) resource.

15. The method of claim 11,
wherein the two REs to which the DMRS has been assigned and the RE to which the PTRS has been assigned are located on a same subcarrier.

16. A base station for receiving a phase tracking reference signal (PTRS) in a wireless communication system, the base station comprising:
a transceiver; and
a controller coupled with the transceiver and configured to:
perform linear interpolation based on two resource elements (REs) to which a demodulation reference signal (DMRS) has been assigned, to acquire a first channel frequency response (CFR) estimation value in an RE to which the PTRS has been assigned;
acquire an estimation value of a common phase error (CPE) angle difference for the RE to which the PTRS has been assigned; and
based on a second CFR estimation value acquired by applying the estimation value of the CPE angle difference to the first CFR estimation value, perform phase tracking of the RE to which the PTRS has been assigned.

17. The base station of claim 16, wherein the controller is further configured to:
acquire the estimation value of the CPE angle difference by filtering a reception signal at a frequency, where the RE to which the PTRS has been assigned exists, using a whitened matched filter in the spatial domain, and accumulating a result value of the filtering in the whitened matched filter; and
acquire the first CFR estimation value based on the REs to which the DMRS has been assigned, the REs being close in the time domain to the RE to which the PTRS has been assigned.

18. The base station of claim 16,
wherein the REs to which the DMRS has been assigned are two REs closest in the time domain to the RE to which the PTRS has been assigned.

19. The base station of claim 16, wherein the two REs to which the DMRS has been assigned and the RE to which the PTRS has been assigned are located within a physical uplink shared channel (PUSCH) resource.

20. The base station of claim 16,
wherein the two REs to which the DMRS has been assigned and the RE to which the PTRS has been assigned are located on a same subcarrier.
